(19) United States
(12) Patent Application Publication
(10) Pub. No.: US 2006/0106512 A1
(43) Pub. Date: May 18, 2006

(54) Method and device for monitoring an accelerator sensor

(76) Inventors: Guido Funcke, Besigheim-Ottmarsheim (DE); Thomas Klotzbuecher, Rudersberg (DE); Thomas Linke, Waiblingen (DE); Johannes Meiwes, Markgroeningen (DE); Heinz Fuchs, Benningen (DE); Karl-Heinrich Weis, Leonberg (DE)

Correspondence Address: KENYON & KENYON LLP, ONE BROADWAY, NEW YORK, NY, 10004, US

(21) Appl. No.: 10/531,551

(22) PCT Filed: Jul. 11, 2003
(86) PCT No.: PCT/DE03/02339

§ 371 Date: Sep. 2, 2005

(30) Foreign Application Priority Data
Oct. 19, 2002 (DE) 102 48 805.3

(51) Int. Cl. G06F 7/00; G01M 17/00

(52) U.S. Cl. 701/34

(57) ABSTRACT

A partially redundant, contactless pedal-travel sensor is used for controlling a vehicle. This pedal travel sensor generates at least two redundant signals using a contactless sensor and an electronic circuit. These signals are fed to a control and/or regulating unit, where they are subjected to a plausibility check to detect a faulty pedal-travel sensor. To improve safety during a failure of a pedal-travel sensor and to improve the diagnostic options, it is provided that a specific position of the pedal is detected by a switch and a signal is generated by the switch. Then a plausibility comparison of the signal generated by the switch with the signals generated by the pedal-travel sensor is performed.

### FIELD OF THE INVENTION

The present invention relates to a method for controlling a vehicle, in which the position of a pedal is detected by a sensor, at least two redundant signals corresponding to the position of the pedal are generated with the aid of this sensor, and a plausibility check of the redundant signals generated by this sensor is performed. The present invention also relates to a device for controlling a vehicle including a sensor for detecting the position of a pedal, with the aid of which at least two redundant signals corresponding to the position of the pedal are generated; and a control and/or regulating unit for controlling and/or regulating a vehicle that is capable of performing a plausibility check of the redundant signals. The present invention also relates to a computer program which is executable on a computer, particularly on a microprocessor.

### BACKGROUND INFORMATION

A method of the type described above is available in the market. In this conventional method, a driver command is transmitted via an accelerator pedal. The position of the accelerator pedal is detected via two independent potentiometers, so-called pedal-travel sensors. From each of these potentiometers, a signal describing the position of the accelerator pedal is then transmitted to the control unit. In the control unit, a plausibility check is then performed using these redundant signals so as to be able to detect a defective pedal-travel sensor and take suitable measures.

Redundant systems are frequently used in safety-relevant environments to increase safety in the event of a system failure on the one hand and, on the other hand, to be able to perform a fault detection using a plausibility check. Depending on the type and extent of the detected faults, appropriate measures can then be initiated.

In the system described above, for example, at least two signals for detecting a driver command are generated and transmitted to the control unit. In this context, the driver command can be transmitted via a pedal, for example an accelerator pedal, a brake pedal or a clutch pedal, and/or a device for detecting the steering angle and/or for detecting a gear ratio preselection.

The control unit then uses these redundant signals for fault detection, as described in German Patent Application No. DE 100 63 584 for example.

German Patent Application No. DE 100 06 958 describes a method for the diagnosis of a dual potentiometric sensor which detects a faulty sensor on the basis of a comparison of the two output signals.

Particularly for the power control of vehicles, systems are also used that are made up of a potentiometric pedal-travel sensor and a switch for detecting the idle position. German Patent No. DE 43 39 693 A1, for example, describes such a switch for detecting the idle position.

In so-called contactless sensors, contactless position sensors are increasingly used, the signals of which are conditioned by electronic circuits. These electronic circuits are generally programmed microprocessors, which are also known as ASICs (Application Specific Integrated Circuits) and which are already integrated in the sensors. So that the signal generated by the sensors can be transmitted to the control unit, it is generally amplified with the aid of an output stage that is likewise integrated in the sensors.

In this connection, a distinction is made between fully redundant systems and partially redundant systems. Fully redundant systems include two microprocessors per sensor for preprocessing the signal, each microprocessor having an output stage. In partially redundant system, only one microprocessor is used for preprocessing the signal, the preprocessed signals then being transmitted to the control unit via two output stages working in parallel.

Although partially redundant systems are more cost-effective than fully redundant systems, they do not provide any safety in the case of microprocessor failure. Although fully redundant systems by contrast offer increased safety in the case of a failure of the microprocessor, they are comparatively expensive, and here it can also happen that both subsystems fail at the same time. A total failure of a fully redundant system is not completely improbable since both subsystems are constructed in the same way and are situated locally in close proximity to each other such that strong electromagnetic or mechanical forces, for example, always act on both subsystems.

### SUMMARY

An object of the present invention is to provide redundancy for sensors, particularly pedal-travel sensors, which, on the one hand, can be implemented more cost-effectively than a fully redundant system, and which, on the other hand, has improved options for failure diagnosis.

In accordance with example embodiments of the present invention, a particular position of the pedal is detected by a switch and a signal is generated by the switch, and a plausibility comparison of the signal generated by the switch with the signals generated by the sensor is performed.

The switch here represents a system that is mechanically and electronically independent of the pedal-travel sensor. This reduces the probability of a simultaneous failure of the pedal-travel sensor and the switch and increases the redundancy of the overall system. At the same time, a switch of this type is very inexpensive, so that the increased redundancy can nevertheless be achieved in a cost-effective manner.

In an advantageous refinement of the example method, suitable measures for handling the fault are implemented when a faulty signal is detected.

For example, if a fault is detected as a result of a comparison of the two signals from the partially redundant pedal-travel sensor, then the signal of the switch can be additionally used to generate a decision regarding suitable and, as it were, “custom-tailored” measures. The existence of the quantity of the switch, however, also makes it possible to detect a complete failure of a pedal-travel sensor.

For example, if the pedal-travel sensor is an accelerator pedal-travel sensor that detects the driver's power output command by the position of an accelerator pedal and transmits it, and if the switch is an idle switch, then, with the aid of this switch, it is possible to detect whether the accelerator pedal is operated by the driver at all. This can be used to determine whether a power output command on the part of the driver is pending or whether the vehicle is to be operated at idle speed. If the accelerator pedal-travel sensor in this example delivers irregular signals and the idle switch does not indicate a power output command on the part of the driver, then for safety reasons the control unit will for example take measures to operate the vehicle at idle speed.

If in the case of irregular signals of the accelerator pedal-travel sensor, however, the switch detects a power output command on the part of the driver, the control unit can for example operate the vehicle at low power output, ensuring that the driver has a basic, albeit limited, mobility, to be able to leave the area of an intersection, for example, or to be able to drive to a nearest service station.

Thus, compared to a fully redundant concept, the redundancy concept proposed here has the advantage that it is not only more cost-effective to implement but also that in the case of a detected fault, suitable measures can be initiated corresponding to a fault type.

In an example embodiment of the method, the signal generated by the switch is fed directly to a control and/or regulating unit.

Thus, the transmission of the signal generated directly or indirectly by the switch is independent of the signals generated directly or indirectly by the pedal-travel sensor. This additionally reduces a probability of failure of the overall system due to the fact that fault sources of additional transmitting means are excluded. Moreover, the signal transmission of the signals generated by the switch is thus independent of the faults that can occur in the transmission of the signals of the pedal-travel sensor.

Advantageously, in the method according to an example embodiment of the present invention, the signal generated by the switch is combined with the first signal generated by the sensor to form combined information, the combined information is transmitted to the control and/or regulating unit, and in the control and/or regulation unit, information describing the first signal generated by the sensor and the signal generated by the switch is extracted and compared to another signal generated by the sensor in such a way that a faulty pedal-travel sensor is detected.

In the case of an analog transmission path between the pedal-travel sensor and the control unit and between the switch and the control unit, for example, this specific embodiment has the advantage of requiring fewer lines. This allows for example for a simple retrofitting of an already existing partially redundant system due to the fact that no new lines need to be run in the vehicle.

Thus, in an example of an implementation using an analog transmission path, for example, a switch can be used in which a first level of the generated signal corresponds to a zero level in the non-switched state. A second level of this switch is higher in the switched state than a maximum level that the signal of a first output stage of the pedal-travel sensor can assume. Thus, by adding the levels, both signals can be fed to the control unit via a line.

A comparison is then performed in the control unit to determine whether the level present at this line is higher than the maximum level that the signal of the corresponding output stage can assume. If this is the case, then it is assumed that the switch is in the switched state. The signal applied to the control unit via the line is then reduced by the level of the switch and is interpreted as the signal of the output stage of the pedal-travel sensor.

Another example of an implementation is based on a system in which the individual components communicate via a bus system, i.e., in which the signals are transmitted in a digitalized state. Here a combination of the first signal of the pedal-travel sensor with the quantity ascertained by the switch has the advantage of a reduced data volume compared to a method in which the quantity detected by the switch is transmitted directly via the bus system.

A combination of both signals can usually be achieved in a very simple manner. If, for example, a controller area network (CAN) is used to transmit the signals, then the signal of an output stage of the pedal-travel sensor is transmitted in a digitalized state by a sequence of bits within a so-called message. Normally, a single bit is sufficient to transmit a position of a switch. Thus, it suffices, for example, to reserve one bit in each message sent by an output stage of the pedal-travel sensor for transmitting the position of the switch.

In a method according to the present invention, the signal generated by the switch preferably provides information as to whether or not the pedal is in an idle position.

If, for example, a fault has been detected on the basis of the comparison of the signals of the output stages of the partially redundant pedal-travel sensor, then this signal can be used to decide what measures are going to be taken.

If the pedal is an accelerator pedal, for example, and the switch is an idle switch that triggers a switching operation when the accelerator pedal is displaced from the idle state, then, if a case of a fault is detected and the accelerator pedal is not pressed, the power output control of the control unit can for example prompt the vehicle to be operated at idle power. However, if in an otherwise identical situation, the idle switch indicates that the accelerator pedal is pressed, then the power output control of the control unit can bring it about, for example, that the engine speed is adjusted to be just high enough to ensure basic mobility.

Advantageously, in the method according to the present invention, an additional signal may be generated by another switch and a detection of a faulty pedal-travel sensor and at least one faulty switch is performed using the totality of the signals.

For example, beside the idle switch described above, additional switches are installed for detecting a driver command for medium power output and for full power output. With the aid of the information obtained from these switches, more differentiated measures are then put into effect in the control unit in case of a fault. In addition, in this example embodiment of the method, defective switches in the control unit are also detected using a plausibility comparison of the signals of the switches.

If, for example, a comparison of the signals of the output stages of the pedal-travel sensor shows that there is a fault in the pedal-travel sensor, and if three switches detecting different positions of the accelerator pedal indicate that first of all no idle is demanded, that second there is a demand for medium power output and that third full power output is demanded, then the control unit for example can assume with high probability that full power output is indeed demanded and can decide for safety reasons to provide at least half the power output for example.

However, if in this same situation the first switch indicates a demand to idle, then the control unit will decide for example that, in addition to the fault detected in the pedal-travel sensor, at least one switch delivers a faulty quantity, and will, depending on the detected fault of the pedal-travel sensor, for safety reasons operate the vehicle for example at idle speed or at least only at a low power output.

In another example embodiment of the present invention, there is a switch for detecting a specific position of the pedal, which is used to generate a signal, and the control and/or regulating unit has means for performing a plausibility comparison of the redundant signals generated by the switch and by the sensor.

The advantages of this example device and of the subsequent specific embodiments result from the above-mentioned advantages of the methods described in the relevant passages.

In an advantageous refinement of the device, the control and/or regulating unit has a device for detecting a faulty signal and for implementing suitable measures for handling faults. In a preferred specific embodiment, the switch is directly connected to the control unit via a line.

Advantageously, a device according to the present invention is configured in such a way that a device is provided for combining the first signal generated by the sensor with the signal generated by the switch to form combined information; a device is provided to feed the combined information to the control and/or regulating unit; and the control and/or regulating unit has a device to extract information, describing the first signal generated by the sensor and the signal generated by the switch, from the combined information and for comparing this information with another redundant signal generated by the sensor and for detecting a faulty pedal-travel sensor.

In a device according to the present invention, the switch is preferably an idle switch.

A preferred specific embodiment of the device includes at least one additional switch for detecting a specific position of the pedal, which is used to generate a signal, and means in the control and/or regulating unit for detecting a faulty pedal-travel sensor and at least one faulty switch by using the totality of the signals.

Implementing the present invention in the form of a computer program may be particularly important. The computer program may be executable on a computer, particularly on a microprocessor, and is suitable for carrying into effect the method according to the present invention. Thus, in this case, the present invention is implemented by the computer program, so that this computer program represents the present invention in the same manner as does the method, for the execution of which the computer program is suitable. The computer program is preferably stored in a memory element. In particular, a random-access memory, a read-only-memory or a flash memory may be used as memory element.

### BRIEF DESCRIPTION OF THE DRAWINGS

Further features, uses and advantages of the present invention come to light from the following description of exemplary embodiments of the present invention shown in the drawings. In this connection, all of the described or represented features, by themselves or in any combination, form the subject matter of the present invention, regardless of their formulation and representation in the description and in the figures.

FIG. 1 shows an overall view of a fundamental structure of a device for controlling and regulating an internal combustion engine.

FIG. 2 shows a block diagram of a partially redundant pedal-travel sensor and a switch, the switch being directly connected to a control unit.

FIG. 3 shows an additional block diagram of a partially redundant pedal-travel sensor and a switch, the signal generated via the switch being combined with a redundant signal of the sensor.

FIG. 4 shows a flow chart of a plausibility check of the signals generated by a sensor and by a switch.

### DETAILED DESCRIPTION OF EXAMPLE EMBODIMENTS

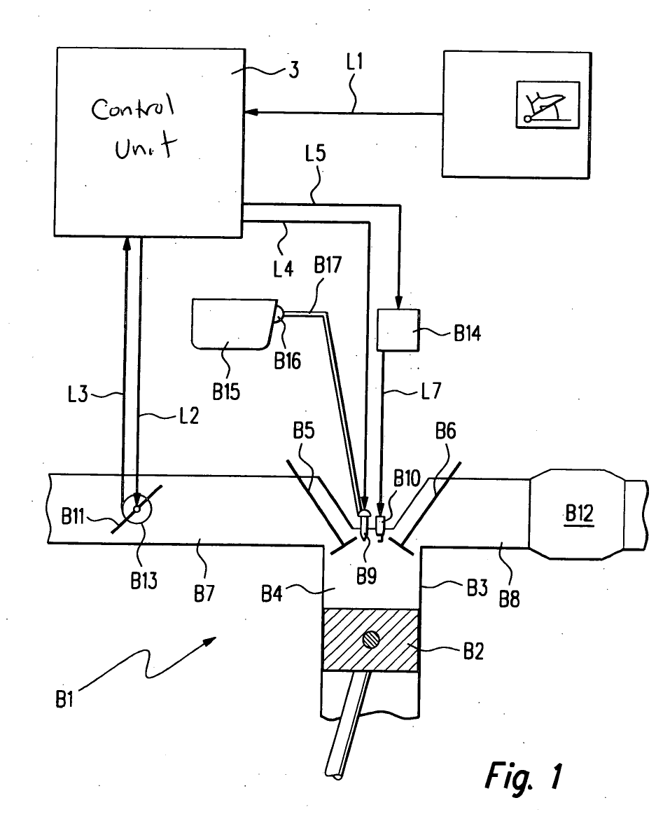

FIG. 1 shows an example of a fundamental structure of an internal combustion engine B1 having a control unit 3. Internal combustion engine B1 includes a cylinder B3, in the interior of which a piston B2 is guided in a moveable manner. Situated on the side of cylinder B3 opposite of piston B2 there is an intake valve B5, a discharge valve B6 as well as an injector nozzle B9 for injecting fuel and a spark plug B10 for igniting the fuel-air mixture. The interior of cylinder B3 forms a combustion chamber B4, which is bounded by an inner cylinder wall (without reference numeral), by piston B2 as well as by intake valve B5 and discharge valve B6.

Injector nozzle B9 is connected to the control unit via a control line L4. In addition, a fuel pump B16 connected to injector valve B9 via a fuel line B17 is attached to a fuel reservoir tank B15. An ignition coil B14 is connected to control unit 3 via a control line L5 and to spark plug B10 via a high-voltage line B7.

An intake duct B7 leads into combustion chamber B4 via intake valve B5. A throttle valve B11, which is controllable by control unit 3 via a control line L2, is mounted in intake duct B7. In addition, a sensor B13 for detecting the position of throttle valve B11 is mounted in the intake duct. The signals generated via sensor B 13 are fed to control unit 3 via line L3.

An exhaust duct B8 leads into combustion chamber B4 via exhaust valve B6. Exhaust duct B8 is attached to an exhaust pipe including an emission control system B12. A pedal-travel sensor 1 for detecting the position of a pedal is also represented. Pedal-travel sensor 1 is connected to control unit 3 via a line L1.

The basic principle of operation of the internal combustion engine shown in FIG. 1 is as follows:

While intake valve B5 is open, an air mass controllable in volume by the position of throttle valve B11 enters combustion chamber B4 via intake duct B7 in the course of a power cycle of piston B2. In combustion chamber B4, a fuel mass controllable by control unit 3 is injected via injector nozzle B9. Subsequently, the fuel-air mixture in combustion chamber B4 is ignited by a spark generated at spark plug B10.

In the operation of internal combustion engine B1, particularly in a vehicle, a signal from pedal-travel sensor 1 describing a position of an accelerator pedal and thus a power output request on the part of the driver is fed to control unit 3. Control unit 3 then prompts throttle valve B11 via line L2 and an actuator (not shown) to assume a specified position. Via position sensor B13, control unit 3 ascertains whether the position of the throttle valve corresponds to the specified value.

In the device represented, the position of the accelerator pedal ascertained by the pedal-travel sensor is also used by control unit 3 to control the fuel quantity and the timing of an injection of fuel into combustion chamber B4 via injector nozzle B9.

In addition, control unit 3 controls the timing of an ignition of the fuel-air mixture in the combustion chamber via line L5 and ignition coil B14.

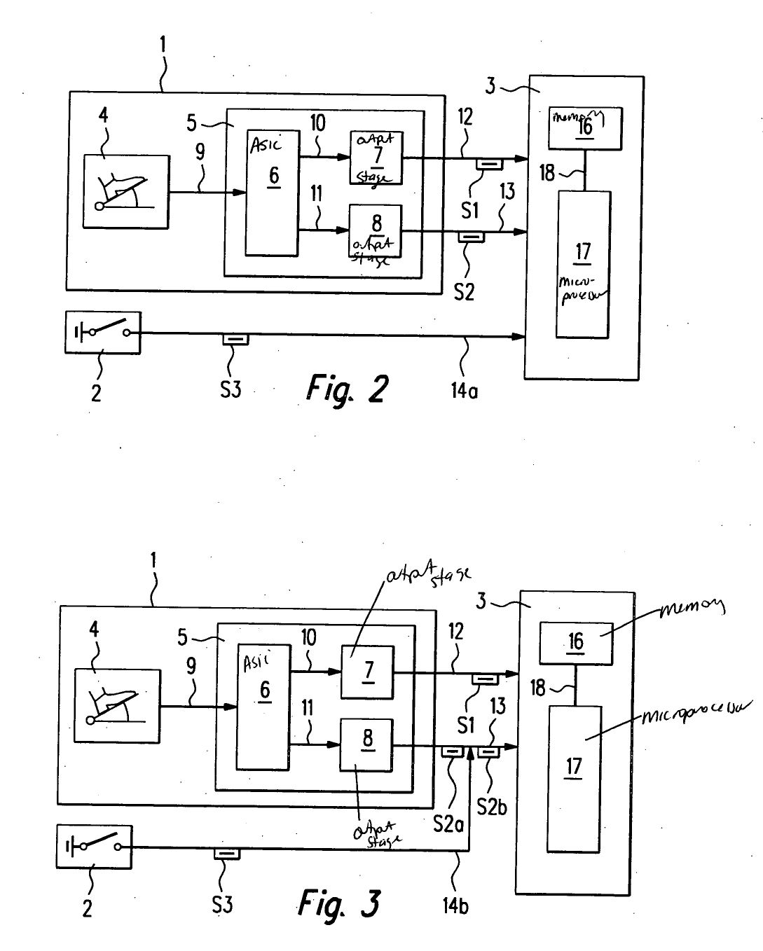

FIG. 2 shows a first exemplary embodiment of a device 20 for controlling a vehicle made up of a partially redundant, contactless pedal-travel sensor 1 already shown in FIG. 1, which is connected to control unit 3 via signal lines 12 and 13, and a switch 2, which is likewise connected to control unit 3 via a signal line 14a. Partially redundant, contactless pedal-travel sensor 1 includes a position sensor 4 connected to a pedal 15 and a partially redundant electronic circuit 5. This electronic circuit 5 includes a signal-conditioning device, which is implemented as a programmed microprocessor 6 (ASIC), and two output stages 7 and 8. Control unit 3 includes a memory 16 and a microprocessor 17 connected via a bus system 18.

The device shown in FIG. 2 operates as follows:

Via line 9, the signal S0 ascertained by position sensor 4 is fed to device 6 for signal conditioning. Signal S0 is then concurrently transmitted via lines 10 and 11 to output stages 7 and 8 and from there is fed to control unit 3 via lines 12 and 13. Switch 2 is a so-called idle switch which detects whether the pedal is in the idle position and which transmits this information in the form of a signal S3 to control unit 3 via line 14a.

A comparison of the signals S1, S2 fed by pedal-travel sensor 1 to control unit 3 via lines 12 and 13 allows control unit 3 to detect a faulty pedal-travel sensor 1. If a pedal-travel sensor has been detected as faulty, then control unit 3 uses the information S3 transmitted from switch 2 via line 14a to diagnose the fault situation.

If idle switch 2 indicates, for example, that pedal 15 is in the idle position, then (in case a discrepancy is detected between signals S1 and S2) the control unit will take measures to operate the vehicle at idle speed. If idle switch 2 by contrast indicates that the driver is holding pedal 15 in a depressed position, then control unit 3 will choose for example the signal S1 or S2 of output stages 7 and 8 that corresponds to the lower power output requirement.

Idle switch 2 consequently provides an additional deciding criterion for the selection of a procedure on the part of control unit 3 in case of a faulty pedal-travel sensor 1. Furthermore, with the appropriate programming of control unit 3, an idle switch allows the driver to control the vehicle, albeit in a highly restricted manner, in the event of a total failure of pedal-travel sensor 1.

This can be done, for example, in that, when the accelerator pedal is depressed, control unit 3 provides a power output that allows for a basic movement of the vehicle.

FIG. 3 shows another specific embodiment of a device for controlling a vehicle. In this instance, areas, elements and blocks having equivalent functions to areas, elements and blocks of the exemplary embodiment shown in FIG. 1 have the same reference numerals. Unless absolutely required, they are not explained again in detail.

In the device shown in FIG. 3, the signal S3 generated via switch 2 is not fed directly to control unit 3, but is combined with signal S2a of output stage 8. To this end, the level of signal S3 generated via switch 2 is added to the level of signal S2a generated by pedal-travel sensor 1. This is indicated by signal transmission line 14b. The signal S2b thus produced is then fed to control unit 3 via line 13.

In this example embodiment, control unit 3 includes a device or arrangement to extract, from combined signal S2b, which is fed to control unit 3 via line 13, information describing signal S2a originally generated by pedal-travel sensor 1 and signal S3 generated by the switch.

Thus in this specific embodiment, an already existing, partially redundant, contactless pedal-travel sensor 1 is combined with a switch 2. This increases fault detection and improves the options for fault diagnosis without requiring the installation of new lines from switch 2 to control unit 3.

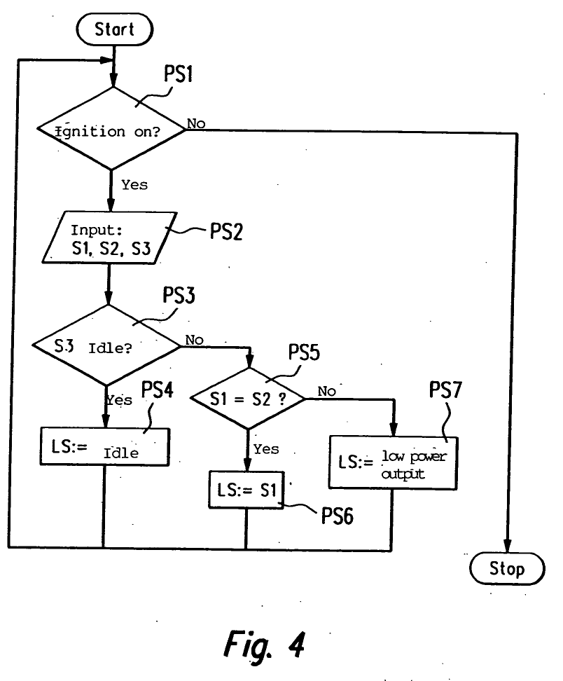

FIG. 4 shows a highly simplified flow chart of a method for operating one of the devices of FIGS. 2 or 3, which can be used to perform in a vehicle a simple plausibility check of signals S1, S2, S3 in control unit 3.

The method shown in FIG. 4 assumes a dominance of switch 2. This means that signal S3 generated via switch 2 is always assumed as decisive for selecting a suitable power output control. At the same time, it is assumed in this example that signal S3 arriving in control unit 3 is error-free.

The plausibility check is performed for example as soon as the internal combustion engine starts up. In a first query step PS1, a check is then performed to determine whether the ignition is switched on. If this is not the case, then the plausibility check is terminated. If the ignition is switched on, however, then, initially in step PS2, signals S1, S2, S3 are provided in suitable form, as binary coded quantities in the registers of microprocessor 17 for example.

In a query step PS3, a check is performed to determine whether signal S3 generated by switch 2 indicates an idle request. If this is the case, then in program step PS4 a value LS, which indicates a setpoint value of the power output of the internal combustion engine, is set to a value corresponding to idle speed. At this point the dominance of switch 2 chosen for this simple specific embodiment becomes evident. Here the power of the internal combustion engine is controlled without taking the signals generated by pedal-travel sensor 1 into account.

If signal S3 does not indicate an idle request, then there is branching to the query step PS5. There a check is performed to determine whether signal S1 and signal S2 describe the same pedal travel. If this is the case, then the pedal-travel sensor is diagnosed as error-free. In program step PS6, the power output request transmitted by signals S1, S2 is then taken over as a setpoint value.

In the alternative case, the pedal-travel sensor is diagnosed as faulty. Since switch 2 signals a power output request, however, in a program step PS7, setpoint value LS is set to a predefined value, which ensures a maneuvering capability on the part of the vehicle.

1-15. (canceled)

16. A method for controlling a vehicle, comprising:
detecting, by a sensor, a position of a pedal;
generating, by the sensor, at least two redundant signals corresponding to the position of the pedal;
performing a plausibility check of the redundant signals generated with the aid of the sensor;
detecting the position of the pedal using a switch, the switch generating a signal; and
performing a plausibility comparison of the signal generated by the switch with the signals generated by the sensor.

17. The method as recited in claim 16, further comprising:
implementing measures for handling a fault in the event that a faulty signal is detected.

18. The method as recited in claim 16, further comprising:
feeding the signal generated by the switch directly to at least one of a control unit and regulating unit.

19. The method as recited in claim 1, wherein:
the signal generated by the switch is combined with a first one of the signals generated via the sensor to form combined information;
the combined information is transmitted to at least one of a control unit and a regulating unit; and
in the at least one of the control unit and regulating unit, information describing the first one of the signals generated by the sensor and the signal generated by the switch is extracted and compared to another one of the signals generated by the sensor in such a way that a faulty pedal-travel sensor is detected.

20. The method as recited in claim 1, wherein the signal generated by the switch provides information as to whether or not the pedal is in an idle position.

21. The method as recited in claim 20, further comprising:
generating an additional signal is generated by at least one further switch; and
detecting a faulty pedal-travel sensor and at least one faulty switch using a totality of the signals.

22. A device for controlling a vehicle, comprising:
a sensor to detect the position of a pedal, at least two redundant signals corresponding to the position of the pedal being generated with the aid of the sensor; and
at least one of a control unit and a regulating unit to at least one of control and at least one of regulating a vehicle, which is capable of performing a plausibility check of the redundant signals; and
a switch to detect a position of the pedal, the switch being used to generate a signal;
wherein the at least one of the control unit and the regulating unit includes an arrangement to perform a plausibility comparison of the redundant signals generated by sensor and the signal generator by the switch.

23. The device as recited in claim 22, wherein the at least one of the control unit and the regulating unit includes an arrangement to detect a faulty signal and to implement measures for handling faults.

24. The device as recited in claim 22, wherein the switch is directly connected to the at least one of the control unit and the regulating unit via a line.

25. The device as recited in claim 22, further comprising:
an arrangement configured to combine a first one of the signals generated by the sensor with the signal generated by the switch to form combined information; and
an arrangement to feed the combined information to the at least one of the control and the regulating unit;
wherein the at least one of the control unit and the regulating unit includes an arrangement to extract information describing the first one of the signals generated by the sensor and the signal generated by the switch from the combined information and to compare the extracted information with a second one of the redundant signals generated by the sensor, and to detect a faulty pedal-travel sensor.

26. The device as recited in claim 22, wherein the switch is an idle switch.

27. The device as recited in claim 22, further comprising:
at least one additional switch to detect a position of the pedal, the at least additional switch being used to generate a signal;
wherein the control unit and the regulating unit includes an arrangement to detect a faulty pedal-travel sensor and at least one faulty switch by using totality of the signals.

28. A memory device storing a computer program that is executable on a microprocessor, the computer program when executed on the microprocessor, controlling a vehicle to perform;
detecting, by a sensor, a position of a pedal;
generating, by the sensor, at least two redundant signals corresponding to the position of the pedal;
performing a plausibility check of the redundant signals generated with the aid of the sensor;
detecting the position of the pedal using a switch, the switch generating a signal; and
performing a plausibility comparison of the signal generated by the switch with the signals generated by the sensor.

29. The memory device as recited in claim 28, wherein the computer program further causes the microprocessor to control the vehicle to perform:
implementing measures for handling a fault in the event that a faulty signal is detected.

30. The memory device recited in claim 28, wherein the device is one of a random-access memory, a read-only memory, or a flash memory.
